(19) United States
(12) Patent Application Publication
(10) Pub. No.: US 2016/0185013 A1
(43) Pub. Date: Jun. 30, 2016

(54) Cross-Linked Core Mold

(71) Applicant: Matt Wallen, Vail, AZ (US)

(72) Inventor: Matt Wallen, Vail, AZ (US)

(21) Appl. No.: 14/969,812

(22) Filed: Dec. 15, 2015

Related U.S. Application Data
(60) Provisional application No. 62/092,654, filed on Dec. 16, 2014.

(51) Int. Cl. B29C 33/38; B29C 35/02; B29C 53/82; B29C 33/52; B29C 33/40; B29C 41/40; B29C 53/56; B29C 41/02

(52) U.S. Cl. CPC B29C 33/3807; B29C 53/56; B29C 35/02; B29C 41/02; B29C 33/52; B29C 33/40; B29C 41/40; B29C 53/822; B29K 2909/08; B29K 2903/08

(57) ABSTRACT

A mandrel or core mold is used in the manufacture of composite products. The current invention avoids the disadvantages of plaster mandrels by making mandrels or core molds composed of aggregate with a dual binder system. This system produces a mold with high green strength, high dry strength, and the ability to be disintegrated from a finished composite product. The cross-linked polyvinylpyrrolidone, poly-polyvinylpyrrolidone, of this invention provides many benefits and advantages.

### RELATED APPLICATIONS

This application claims the benefits of U.S. Provisional Application 62/092,654, filed Dec. 16, 2014.

### FIELD OF THE INVENTION

The present invention relates to the manufacture of composite plastic products and the mandrel or core mold used in such manufacture.

### BACKGROUND OF THE INVENTION

Composite plastic parts are of great value in industry because of their high strength and light weight. Tubular, simple and complex, structures are produced by wrapping or coating a core mold, or mandrel, with the composite and curing the composite at appropriately high temperature. The product can be tubular with no seam, being of continuous structure in circumference and length.

Multiple problems arise, however, in creating a core mold of sufficient strength, appropriate surface characteristics, compatibility with the composite and the curing process, and ease of removing the core from the cured composite structure without damage to the composite or significant additional cost.

Core molds, or mandrels, have been made with sand and binders, plaster, plaster mixed with various binders, or fillers such as cenospheres or graphite. Each of these approaches has proved to present problems in having inadequate strength to hold up in coating or wrapping, poor surface characteristics of the mandrel requiring further work on the surface, interference of residual moisture or other chemicals with the curing (and producing defects in) the composite, or difficulty in removing the mandrel (core mold) from the cured composite product.

Plaster has been a much used mandrel material or component because it is cheap, easily handled, and has desirable surface characteristics when hardened. However, plaster containing binders can negate the ease in handling and also be difficult to remove from some composite products. In addition, residual water in plaster-containing mandrels becomes water vapor as the composite is heated to high curing temperatures. The resulting water vapor interferes with the curing composite and creates defects and flaws in the composite. Such mandrels are most useful only for composites with low curing temperatures.

Therefore, partial drying of plaster-containing mandrels is done prior to wrapping or coating the mandrel with composite material. However, the plaster loses its strength upon removing water, severely limiting the proportion of water that can be removed without destroying the required strength of the mandrel.

To avoid the problems with plaster, a core mold, or mandrel, can be composed of an aggregate held together with one or more binder. Utilizing a combination of two binders with an aggregate, such as cenospheres, offers the promise of utilizing the advantages of each binder to provide a mold or mandrel that is sufficiently strong to be handled when green, not yet dried, and the needed strength when dry to perform its function as a mold for forming a composite product. It is also necessary to remove the mold or mandrel from the formed composite after curing. Water washout is desired as rapid, easy, and of low cost.

As the composite product industry has progressed, the demand has increased for higher fidelity with tighter tolerance limits and increased geometric complexity. The concept of using aggregate with a dual binder system is to provide a first binder that hardens immediately for easier de-molding and the second binder to develop dry strength and also allow for a simple water washout for removal from the ultimately formed composite.

The dual binder system utilizing sodium silicate (water glass) and polyvinylpyrrolidone (PVP) with the aggregate cenospheres is attractive, but cannot provide both structural strength for the mandrel and ability to wash it out with water. Conditions that provide the required strength produce a water resistant structure difficult to remove from the composite product. Sodium Silicate “water glass” (W.G.)

Sodium silicate has been used as an aggregate binder for over 100 years. It is comprised of SiO₂ dissolved in a caustic or NaOH. Essentially it is glass forced into a liquid state and held there with a high pH solution. A reduction in the pH of the liquid forces the glass to solidify and bond to its surroundings. This feature is what has made it seem attractive as a binder. By simply passing an acid gas such as CO₂ or SO₂ over the core shape that is coated with the W.G., the acid gas reacts with the caustic instantly to lower the pH and solidify the glass coated shape. This reaction forms an insoluble silicate carbonate requiring removal by mechanical process. The key to this binder is its ability to allow a simple aggregate coated with W.G. to be quickly shaped into the desired form and hardened for removal and further use as a mold or mandrel. Other alkali silicates can be used and act similarly.

### Polyvinylpyrrolidone (PVP)

PVP is a water soluble polymer, able to withstand temperatures up to 174-178° C. and still dissolve like the original polymer. Thus, PVP inclusion can make the shape water removable. It also is able to upon dehydration impart greater strength than the W.G. and then quickly re-dissolve to wash away. However, PVP provides no green strength until it is partially dehydrated.

Theoretically, the combination of the two binders into an aggregate system allows the good attributes of each to compliment the shortfalls of the other. The W.G. imparts a rapid green strength allowing the mold to be recovered to produce an additional part and the PVP gives greater dehydrated strength and the ability to be dissolved away after the composite product is formed over the mandrel. As with all complimentary systems, however, there is a give and take as both binders must occupy binding sites of the aggregate to form a rigid matrix. The degree of occupation of the binding sites or relative concentration of each binder has drastic effects on the properties of the resulting mold. When the W.G. content is held constant and the PVP is increased, the overall dry strength of the material increases to a point. See FIG. 1.

However, at the same time the green strength of the material is reduced as the increased amount of PVP displaces W.G. on binding sites. See FIG. 2.
For the Water Glass, as it is increased, the green strength increases as shown in FIG. 3.

The higher the W.G. concentration, the higher the green strength, but also the lower the dry strength, and vice versa for the PVP concentration. In addition, as the W.G. is added to a sufficient concentration to provide required green strength, occupying the majority of the aggregate bonding sites, the PVP is no long able to dissolve the shape away when it is time to be removed. It is not possible to obtain adequate green strength with W.G. and retain the water solubility, washability, otherwise provided by PVP.

### DESCRIPTION OF THE DRAWINGS

FIG. 1 shows the effects on compression strength of different amounts of PVP in a mold.

FIG. 2 shows the effects on green strength of different amounts of PVP in a mold.

FIG. 3 shows the effects on green strength of different amounts of water glass in a mold.

FIG. 4 shows the green strength of different samples of molds gassed with CO₂.

FIG. 5 shows the dry strength of different samples of molds.

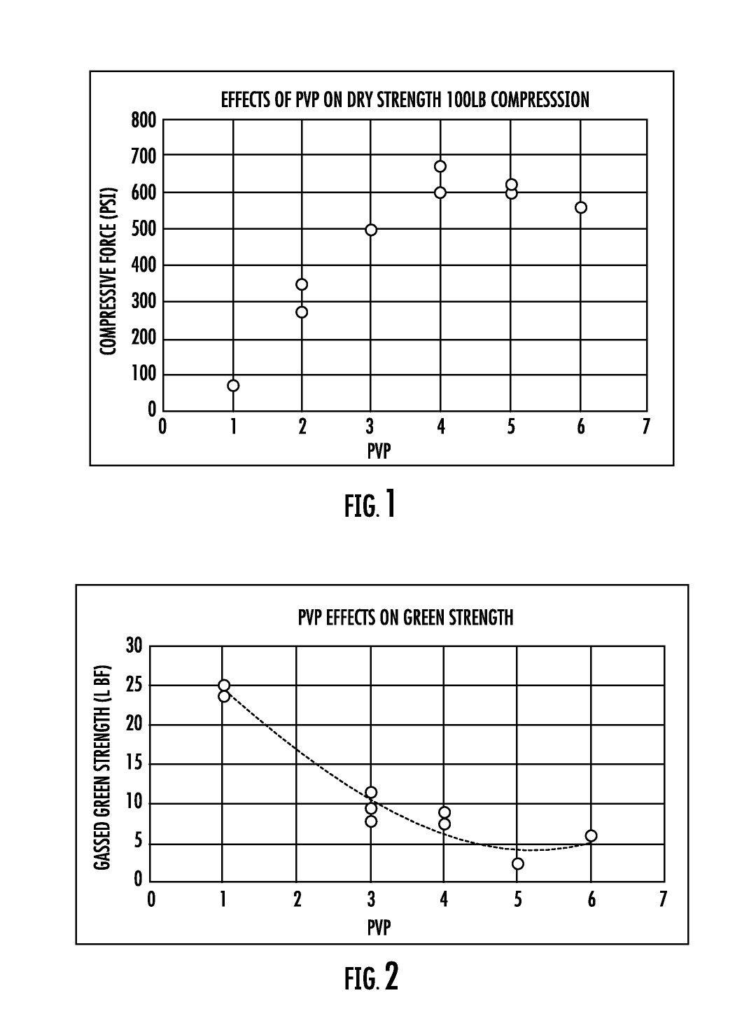

### SUMMARY OF THE INVENTION

The present invention involves forming a mandrel or core mold with aggregate and dual binders. One binder, such as water glass, binds the aggregate in the desired shape before drying the mandrel or mold. Polyvinylpyrrolidone, PVP, is incorporated as the second binder and is polymerized, or cross-linked, in situ to poly-polyvinylpyrrolidone, PPVP, providing critical dry-strength to the mandrel or core mold and is a disintegrant, facilitating the removal of the mandrel or core mold from the finished, cured, composite product.

### DESCRIPTION OF THE INVENTION

The present invention involves chemically converting the PVP in situ to a cross-linked form Poly (Polyvinylpyrrolidone)(PPVP). This can be accomplished either thermally or chemically or utilizing a combination of both. The mechanism for the breakdown of the resulting shape (mandrel) changes from the dissolving of the PVP polymer and all its aggregate connections to a swelling of the PPVP cross-linked polymer which breaks the insoluble W.G. connections (disintegration) making the shape removable. The invention involves forming the disintegrant inside the shape (mandrel).

The disintegrated mandrel is easily removed from the manufactured composite with a stream of water.

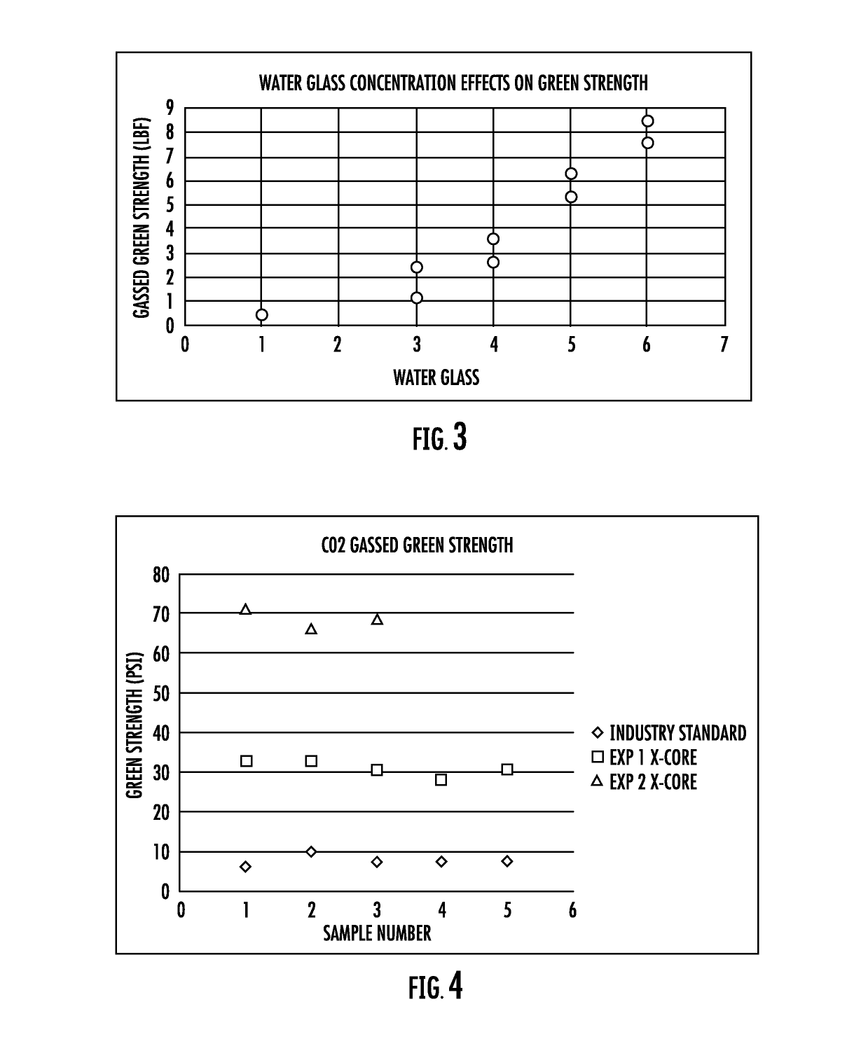

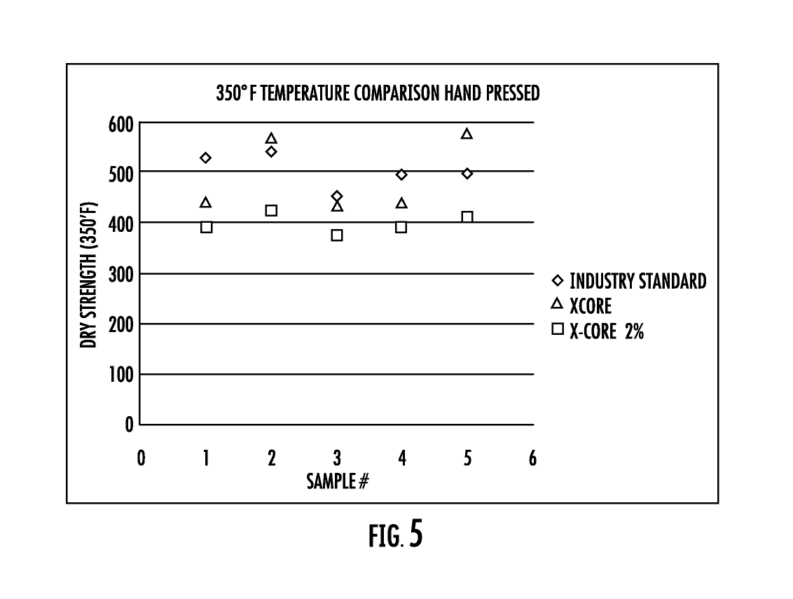

The increase in green strength that is now possible is only one facet of the invention and also how it is accomplished. The FIG. 4 shows the increase in the green strength that is possible utilizing the x-linking technique of the invention (x-core).

The strength data shown in FIG. 4 were produced by mixing ratios of PVP and W.G. that would have previously been insoluble or hard to remove. Polymerizing the PVP in place provides a disintegrant that breaks up the mold when exposed to water and allows much more W.G. (green strength binder) to be utilized, leading to at least an order of magnitude increase in the green strength while also providing easy removal of the mold from the subsequently produced composite product.

There are two problems that arise with the typical use of PVP as a binder in forming mandrels: variability in the size of the PVP in any batch of PVP and moisture-caused softening of the mandrel.

K value is a measure of the molecular chain length of the polymer.

The mechanical integrity of a mandrel made with typical use of PVP as a binder with aggregate is affected by the cure temperature requirement of the reinforced resin systems that are formed onto the shape. The required cure temperature can be near or at the glass transition temperature (Tg) of the PVP. This leaves the mechanical properties in a point of constant fluctuation as Tg is dependent on several variables. The most important impact on the Tg of PVP is the molecular weight of the polymer. The Tg for K-90 grade material is 176-178° C., but a simple reduction in chain length to a K-87 can drop the Tg and result in a loss of mechanical properties or movement in the shape during processing. Manufacturers of the polymer try to maintain as tight of a specification as possible, but K-ranges fluctuate depending on supplier from K82-94. This leaves a chance for getting a material that may soften in process.

In a typical PVP polymer-containing shape the mechanical properties drop by a considerable amount when the K value is too low, leading to softening or weakening of the mandrel at 350° F., which is the standard processing temperature for the composites that are formed around the part. Depending on the forces being applied to the shape, this may result in deviation and in turn failure of the shape/composite forming.

The FIG. 5 shows that deviating from the standard ratios, by utilizing the present invention and cross-linking the PVP within the mold, has little effect at temperature (less than 20% at these non optimized ratios) and will also allow for a cheaper less uniform K-value PVP to be utilized when it is x-linked in the process. The material of this invention containing just 2% PVP, cross-linked to form PPVP, (x-core 2%) is shown to have nearly the strength of comparison materials.

### Moisture-Related Softening.

The other important factor associated with the Tg of PVP is the fact that its mechanical properties are highest when it is fully dehydrated. The Tg of the material is a function of the moisture content of the PVP. Since the shape is comprised of both a highly dehydrated salt W.G. and dehydrated PVP both of which are hygroscopic (water absorbers), the chances of sucking up moisture from the environment is very possible and leads to a reduction in the Tg and reduced mechanical strength of the shape. In this situation water acts as a plasticizer for the PVP, lowering the Tg.

It is a further advantage of the present invention that polymerizing the PVP within the mandrel or core mold, forming PPVP, avoids these problems of reduced mechanical strength or softening.

Essentially, the PPVP mitigates the temperature issue by increasing the effective Tg of the material well above the composite processing temperature so no issues are seen during the processing of the shape to form the composite article.

This also means that the dehydrated form of the desired shape will also be less susceptible to moisture pickup which has been a problem in the past, leading to mandrel failure.

The method of this invention involves the formation of a core mold, or mandrel, utilizing an aggregate such as cenospheres and two binders. The two binders are water glass and PVP at effective concentrations of each. The water glass is solidified using methods known to those skilled in the art, providing initial strength to the mold, or mandrel, and allowing the mold, or mandrel, to be handled and further processed. The contained PVP is then cross-linked into PPVP.

PVP can be in the range of 1% to 20% or higher on a weight basis, optimally 2% to about 10%. Water glass can be from about 4% to 40% on a weight basis, optimally about 5% to about 12% or more.

X-linking of PVP is accomplished by taking the polymer-containing mandrel to in excess of the PVP's Tg for a sufficient amount of time for the polymer start to partially degrade and reorganize to form linkages to other polymers in the vicinity. Alternatively, it can be accomplished by adding an oxidizer to the mixture that is applied to lower the energy requirement to propagate these linkages to form. Cross-linking can also be accomplished by a combination of these processes or by any method known to those knowledgeable in the art.

### Thermal X-Linking:

PVP held in excess of 380° F. for 30-120 minutes.

### Chemical Additive:

Most Peroxides work great as oxidizers but have a short product shelf life. This can be mitigated by utilizing semi-stable salts such as persulfates (Ammonium, Potassium, Sodium). Small amounts in the range of a few % of the PVP concentration will allow the material to X-link during the dehydration cycle which is less than 300° F. Ideally, the parts after gassing are placed directly into a microwave, where with their higher green strength maintains their shape while starting to dehydrate and simultaneously X-link. In this case, the gassed part is placed into the microwave insoluble and is removed in a state that can be washed-out (now containing PPVP). This provides a significant advantage over the previous process in which the mandrel in the microwave would have to reach a significant level of dehydration before the PVP would start to stiffen the material. This normally occurred long after the gassed silicate binder had weakened, allowing the mandrel to change shape during microwave drying.

The current invention polymerizes the PVP to PPVP, strengthening the core mold or mandrel and acting as a disintegrant for easy removal of the mold from the resulting composite product. In this invention the ratio of sites occupied by the water glass (green strength) can be increased beyond the ratio used in systems where the PVP is not cross-linked, allowing a new range of performance. In addition, the concentrations of PVP can be reduced because lower concentrations of PVP are needed with this invention. We have shown that even at 2%, the polymer swells enough to break up the matrix. That is significantly lower than the lowest concentration of PVP (3%) taught to be required when simply using PVP as a binder. It also means a 30% reduction in the PVP which is a major cost driver in the material. Therefore, this invention significantly reduces costs of manufacturing mandrels, or core molds.

In one example, this invention utilizes a low concentration of PVP (less than 3%). In this example, the binders are 2% PVP and 8% W.G. and the rest cenospheres. This mixture produces a green strength that is 10 times higher than normal and the contained poly-PVP, according to the current invention, additionally acts as a disintegrant for removal of the mandrel or core mold from the composite product.

In another example, the binders are 4% PVP and 12% W.G. and the rest cenospheres, according to the current invention the PVP is cross-linked. This produces a mandrel with superior green strength and also is easily removed from finished product as the poly-PVP is swelled by water added after finishing the product, resulting in disintegration of the mandrel or core mold.

Both examples of formulations would produce an insoluble mandrel, or core mold, without the cross-linking of this invention.

What is claimed:

1. The method of forming a composite product comprising the steps:
a. Forming a mandrel or core mold of desired shape with aggregate, a binder that maintains the desired shape while green, and containing an effective amount of polyvinylpyrrolidone,
b. Cross-linking the polyvinylpyrrolidone contained within the mandrel or core mold forming poly-polyvinylpyrrolidone,
c. Wrapping or coating the mandrel or core mold with raw composite and curing the composite under appropriate conditions, and
d. Using water to disintegrate the mandrel or core mold and remove it from the cured composite product.

2. A mandrel or core mold composed of aggregate, a first binder that maintains the desired shape of the mandrel or core mold while green, and a second binder, polyvinylpyrrolidone, that is cross-linked forming poly-polyvinylpyrrolidone.

3. The mandrel or core mold of claim 2 when the first binder is an alkali silicate.

4. The mandrel or core mold of claim 2 when the first binder is sodium silicate.

5. The mandrel or core mold of claim 2 when the first binder is an alkali silicate in an amount greater than about 4% on a weight basis.

6. The mandrel or core mold of claim 2 when the first binder is an alkali silicate in an amount greater than about 4% on a weight basis and the second binder is poly-polyvinylpyrrolidone in an amount greater than about 1%.
